(19) United States
(12) Patent Application Publication
(10) Pub. No.: US 2007/0293206 A1
(43) Pub. Date: Dec. 20, 2007

(54) Cell phone communication management

(75) Inventor: Arnold M. Lund, Sammamish, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/471,431

(22) Filed: Jun. 20, 2006

(51) Int. Cl. H04M 3/42

(52) U.S. Cl. 455/415; 455/466; 709/206

(57) ABSTRACT

Various technologies and techniques are disclosed that enhance an ongoing cell phone communication. A separate computing device determines that a communication is in progress on a cell phone. Information is retrieved from a data store that is related to a party participating in the communication. The information is displayed on a display device of the separate computing device for at least a portion of time that the communication is in progress on the cell phone. Management options related to the communication are displayed on the display device of the separate computing device. The user can manage the communication on the cell phone from the separate computing device using the management options.

### BACKGROUND

Cell phones are an important part of today's society. Due to an ever increasing mobile lifestyle, many users use their cell phone as one of their primary means of communication. Other users may have corporate systems that allow their office phone or virtual number to be forwarded to their cell phone when away from the office or working from a virtual office. While it is quite convenient for the user to use their cell phone for many communications, there is often information stored elsewhere on a different computing device that would be useful to have at hand during the cell phone communication.

### SUMMARY

Various technologies and techniques are disclosed that enhance an ongoing cell phone communication. A separate computing device determines that a communication is in progress on a cell phone, such as by monitoring the cell phone communications over a communication connection or by receiving an alert from the cell phone over the communication connection. Information is retrieved from a data store that is related to a party participating in the communication. The information is displayed on a display device of the separate computing device for at least a portion of time that the communication is in progress on the cell phone. A few non-limiting examples of such information can include detailed caller identification information, a photo of the party, prior history of communications with the party, and/or email communications with the party, etc.

In one implementation, management options related to the communication are displayed on the display device of the separate computing device. A few non-limiting examples of management options include a send to voice mail option, a send an email to the caller option, etc. The user can manage the communication on the cell phone from the separate computing device using the management options.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a system of one implementation.

FIG. 2 is a diagrammatic view of a computer system of one implementation.

FIG. 3 is a diagrammatic view of a device communicator of one implementation operating on the computer system of FIG. 2.

FIG. 4 is a process flow diagram for one implementation of the system of FIG. 1 illustrating the stages involved in using a computing device in combination with a cell phone to enhance a user experience.

FIG. 5 is a process flow diagram for one implementation of the system of FIG. 1 illustrating the stages involved in using a computing device in combination with a cell phone to display additional information relevant to an incoming communication.

FIG. 6 is a process flow diagram for one implementation of the system of FIG. 1 illustrating the stages involved in using a computing device in combination with a cell phone to manage an incoming communication.

FIG. 7 is a process flow diagram for one implementation of the system of FIG. 1 illustrating the stages involved in using a computing device in combination with a cell phone for an outgoing communication.

FIG. 8 is a process flow diagram for one implementation of the system of FIG. 1 that illustrates the stages involved in displaying on a computing device a web page associated with an incoming or outgoing communication on a cell phone.

FIG. 9 is a process flow diagram for one implementation of the system of FIG. 1 that illustrates the stages involved in monitoring a status of a cell phone over a communication connection so additional information/options can be provided when communications are in progress.

FIG. 10 is a process flow diagram for one implementation of the system of FIG. 1 that illustrates the stages involved in receiving an alert from a cell phone to indicate a communication is in progress so additional information/options can be provided when communications are in progress.

FIG. 11 is a simulated screen for one implementation of the system of FIG. 1 that illustrates displaying additional communication information on a computing device when a communication is in process on a cell phone.

FIG. 12 is a simulated screen for one implementation of the system of FIG. 1 that illustrates displaying on a computing device an email inbox filtered with messages from the incoming caller when an incoming communication is being received on a cell phone.

FIG. 13 is a simulated screen for one implementation of the system of FIG. 1 that illustrates displaying call management options when an incoming call is being received on a cell phone.

FIG. 14 is a simulated screen for one implementation of the system of FIG. 1 that illustrates automatically displaying on a computing device the web site of a party being called on a cell phone.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

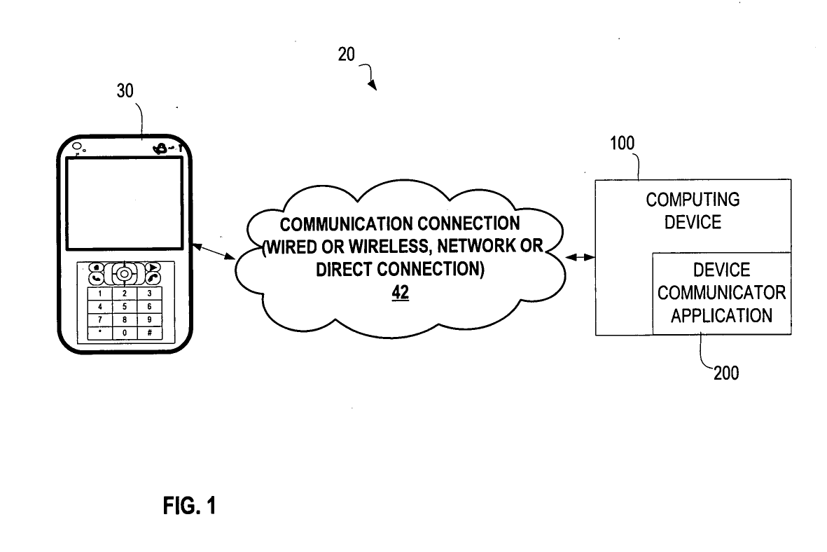

The system may be described in the general context as an application that provides supplemental information/options related to communications happening on a separate device, but the system also serves other purposes in addition to these. As shown in FIG. 1, in one implementation, one or more of the techniques described herein can be implemented as features within a communication system 20 that has a device communicator program 200 operating on a computing device 100 that communicates with a cell phone 30 and then provides additional information/options that supplement the communication happening on the cell phone 30. The cell phone 30 can communicate with the computing device 100 over one or more communication connections 42, such as a wired or wireless connection, and/or a network or direct connection. A few non-limiting examples of wireless connections include WiFi and infrared. A few non-limiting examples of wired connections include USB, serial, wired network connections, etc.

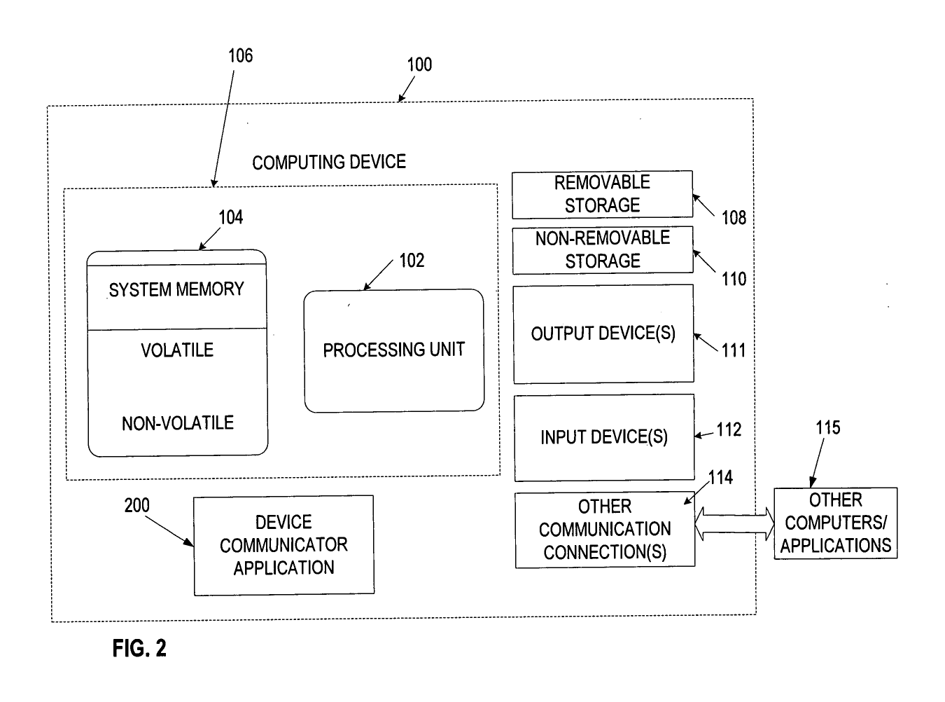

As shown in FIG. 2, an exemplary computer system to use for implementing one or more parts of the system 20 includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

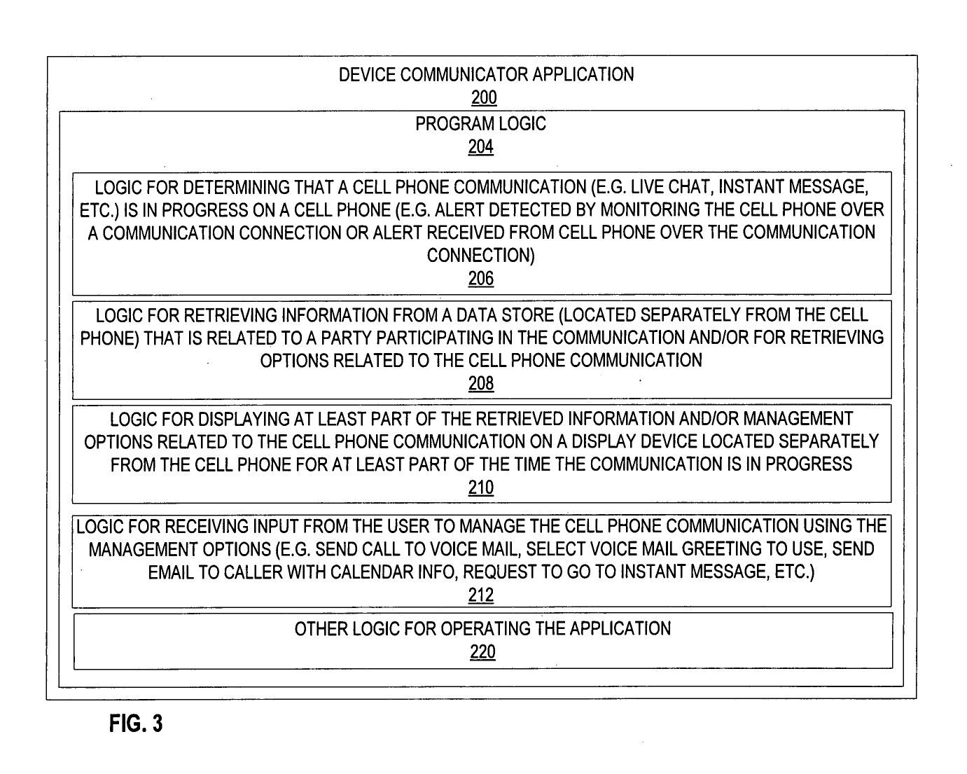

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. As previously mentioned in FIG. 1, in one implementation, computing device 100 includes device communicator application 200. Device communicator application 200 will be described in further detail in FIG. 3.

Turning now to FIG. 3 with continued reference to FIGS. 1 and 2, a device communicator application 200 operating on computing device 100 is illustrated. Device communicator application 200 is one of the application programs that reside on computing device 100. However, it will be understood that device communicator application 200 can alternatively or additionally be embodied as computer-executable instructions on one or more computers and/or in different variations than shown on FIG. 2. Alternatively or additionally, one or more parts of device communicator application 200 can be part of system memory 104, on other computers and/or applications 115, or other such variations as would occur to one in the computer software art.

Device communicator application 200 includes program logic 204, which is responsible for carrying out some or all of the techniques described herein. Program logic 204 includes logic for determining that a cell phone communication (e.g. live chat, instant message, etc.) is in process on a cell phone (e.g. alert detected by monitoring the cell phone over a communication connection or alert received from cell phone over the communication connection) 206; logic for retrieving information from a data store (located separately from the cell phone) that is related to a party participating in the communication and/or for retrieving options related to the cell phone communication 208; logic for displaying at least part of the retrieved information and/or management options related to the cell phone communication on a display device located separately from the cell phone for at least part of the time the communication is in progress 210; logic for receiving input from the user to manage the cell phone communication using the management options (e.g. send call to voice mail, select voice mail greeting to use, send email to caller with calendar info, request to go to instant message, etc.) 212; and other logic for operating the application 220. In one implementation, program logic 204 is operable to be called programmatically from another program, such as using a single call to a procedure in program logic 204.

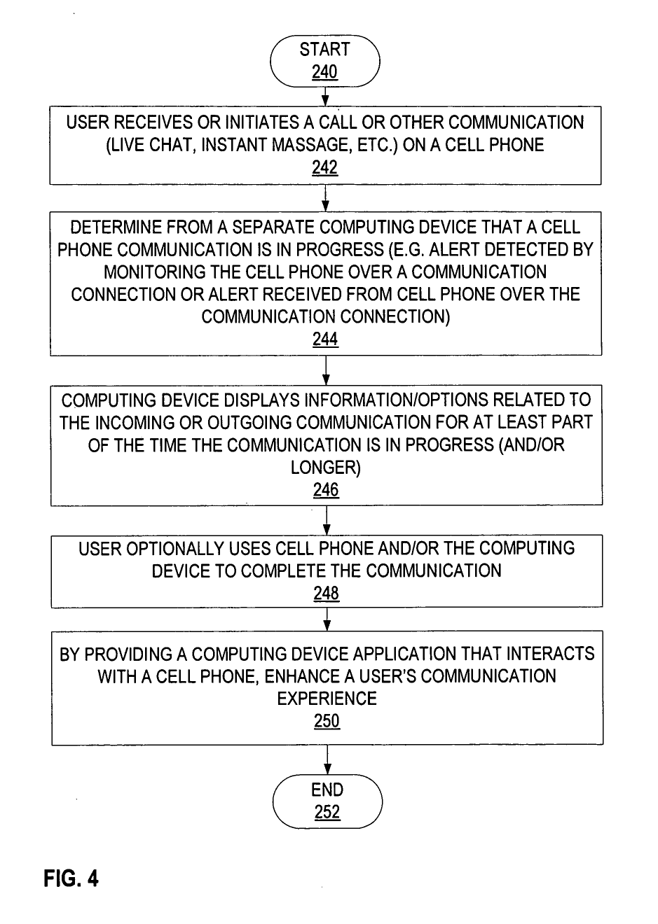

Turning now to FIGS. 4-10 with continued reference to FIGS. 1-3, the stages for implementing one or more implementations of device communicator application 200 are described in further detail. FIG. 4 illustrates one implementation of the stages involved in using a computing device in combination with a cell phone to enhance a user experience. In one form, the process of FIG. 4 is at least partially implemented in the operating logic of computing device 100.

The procedure begins at start point 240 with the user receiving or initiating a call or other communication (live chat, instant message, etc.) on a cell phone (stage 242). A computing device separate from the cell phone determines that the cell phone communication is in progress (e.g. alert detected by monitoring the cell phone over a communication connection or alert received from cell phone over the communication connection) (stage 244). The separate computing device displays information and/or options related to the incoming or outgoing communication for at least part of the time the communication is in progress (and/or longer) (stage 246). The user optionally uses the cell phone and/or the computing device to complete the communication (stage 248). By providing a computing device application that interacts with a cell phone, a user's communication experience is enhanced (stage 250). The process ends at end point 252.

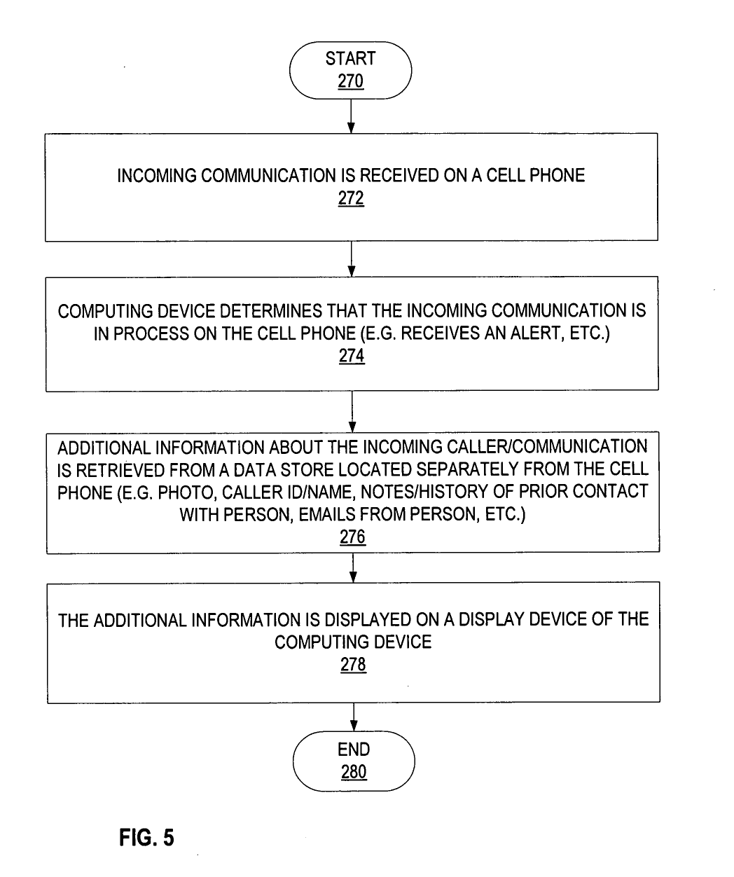

FIG. 5 illustrates one implementation of the stages involved in using a computing device in combination with a cell phone to display additional information relevant to an incoming communication. In one form, the process of FIG. 5 is at least partially implemented in the operating logic of computing device 100. The procedure begins at start point 270 with receiving an incoming communication on a cell phone (stage 272). A computing device separate from the cell phone determines that there is an incoming communication on the cell phone (stage 274). Additional information about the incoming caller/communicator is retrieved from a data store located separately from the cell phone (e.g. photo, caller ID/name, notes/history of contact with person, emails from person, etc.) (stage 276). The additional information is displayed on a display device of the computing device (stage 278). The process ends at end point 280.

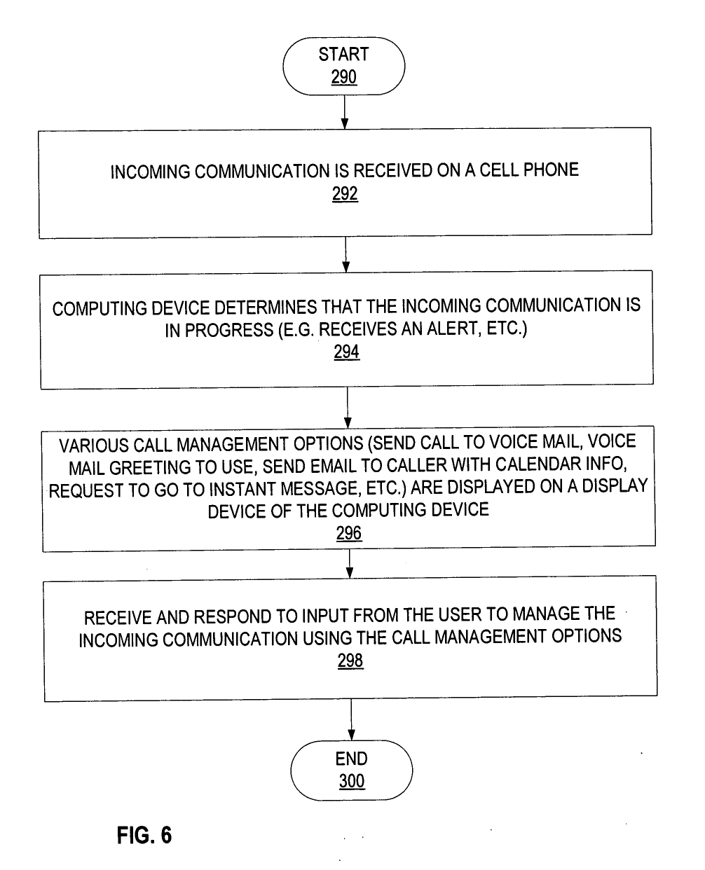

Turning now to FIG. 6, one implementation of the stages involved in using a computing device in combination with a cell phone to manage an incoming communication is shown. In one form, the process of FIG. 6 is at least partially implemented in the operating logic of computing device 100. The procedure begins at start point 290 with an incoming communication being received on a cell phone (stage 292). A computing device determines that the incoming communication is in process (e.g. receives an alert, etc.) (stage 294). Various call management options (send call to voice mail, voice mail greeting to use, send email to caller with calendar info, request to go to instant message, etc.) are displayed on a display device of the computing device (stage 296). The system receives and responds to input from the user to manage the incoming communication using one or more of the call management options (stage 298). The process ends at end point 300.

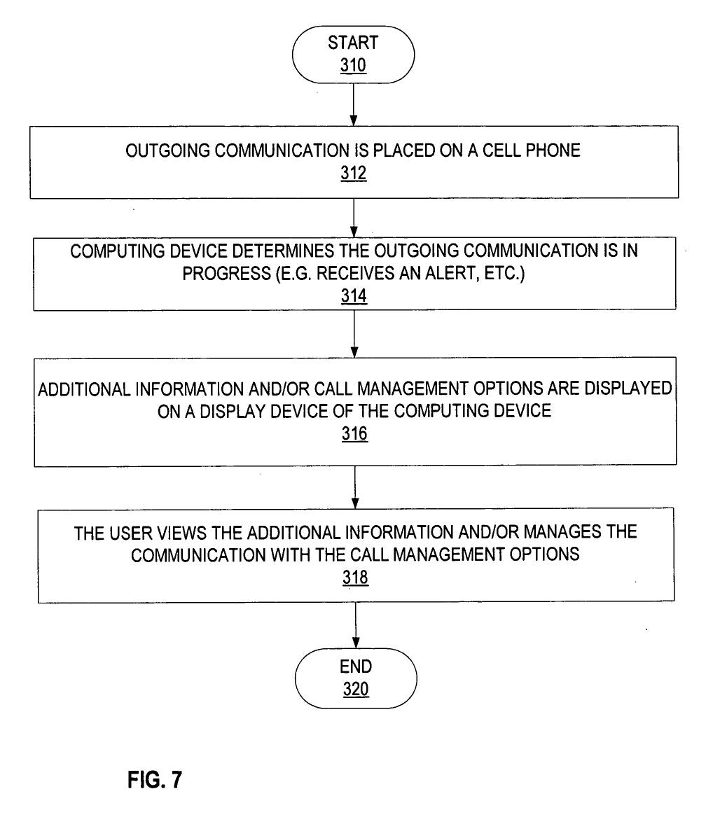

FIG. 7 illustrates one implementation of the stages involved in using a computing device in combination with a cell phone for an outgoing communication. In one form, the process of FIG. 7 is at least partially implemented in the operating logic of computing device 100. The procedure begins at start point 310 with an outgoing communication being placed on a cell phone (stage 312). A computing device determines that the outgoing communication is in process (e.g. receives an alert, etc.) (stage 314). Additional information and/or call management options are displayed on a display device of the computing device (stage 316). The user views the additional information and/or manages the communication with the call management options (stage 318). The process ends at end point 320.

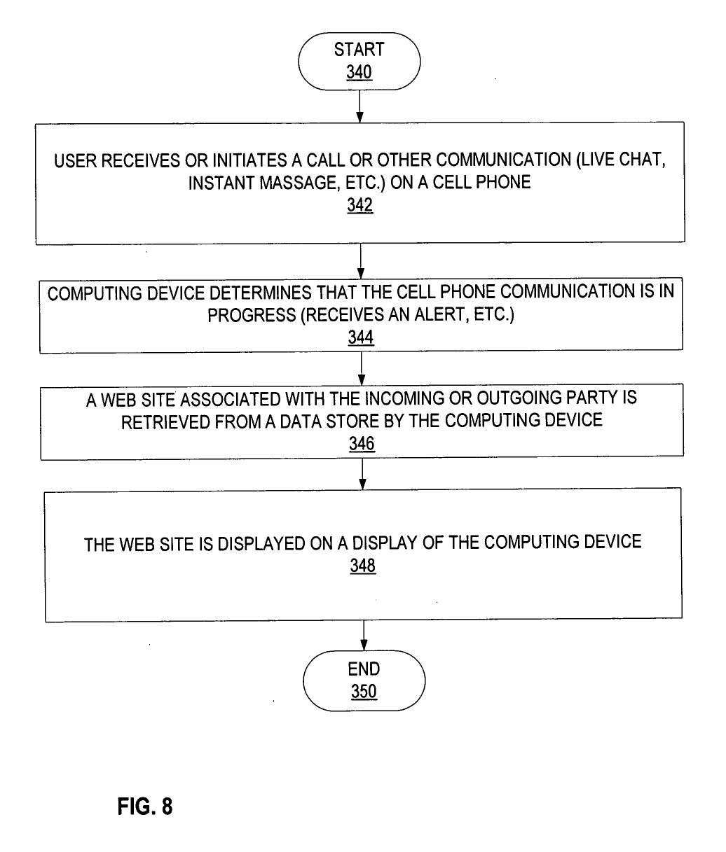

FIG. 8 illustrates one implementation of the stages involved in displaying on a computing device a web page associated with an incoming or outgoing communication on a cell phone. In one form, the process of FIG. 8 is at least partially implemented in the operating logic of computing device 100. The procedure begins at start point 340 with the user receiving or initiating a call or other communication (live chat, instant message, etc.) on a cell phone (stage 342). The computing device determines that the cell phone communication is in process (e.g. by receiving an alert, etc.) (stage 344). A web site associated with the incoming or outgoing party is retrieved from a data store by the computing device (stage 346). The web site is displayed on a display of the computing device (stage 348). The process ends at end point 350.

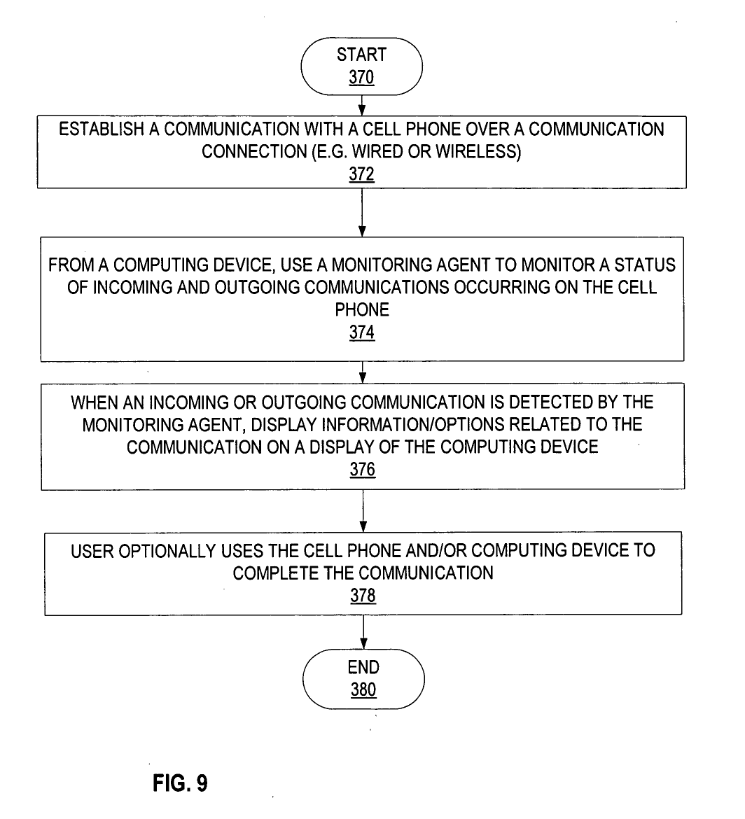

FIG. 9 illustrates one implementation of the stages involved in monitoring a status of a cell phone over a communication connection so additional information/options can be provided when communications are in progress. In one form, the process of FIG. 9 is at least partially implemented in the operating logic of computing device 100. The procedure begins at start point 370 with establishing a communication with a cell phone over a communication connection (e.g. wired or wireless) (stage 372). From a computing device 100, a monitoring agent is used to monitor the status of incoming and outgoing communications occurring on the cell phone (stage 374). When an incoming or outgoing communication is detected by the monitoring agent, information/options related to the communication are displayed on a display of the computing device (stage 376). The user optionally uses the cell phone and/or computing device to complete the communication (stage 378). The process ends at end point 380.

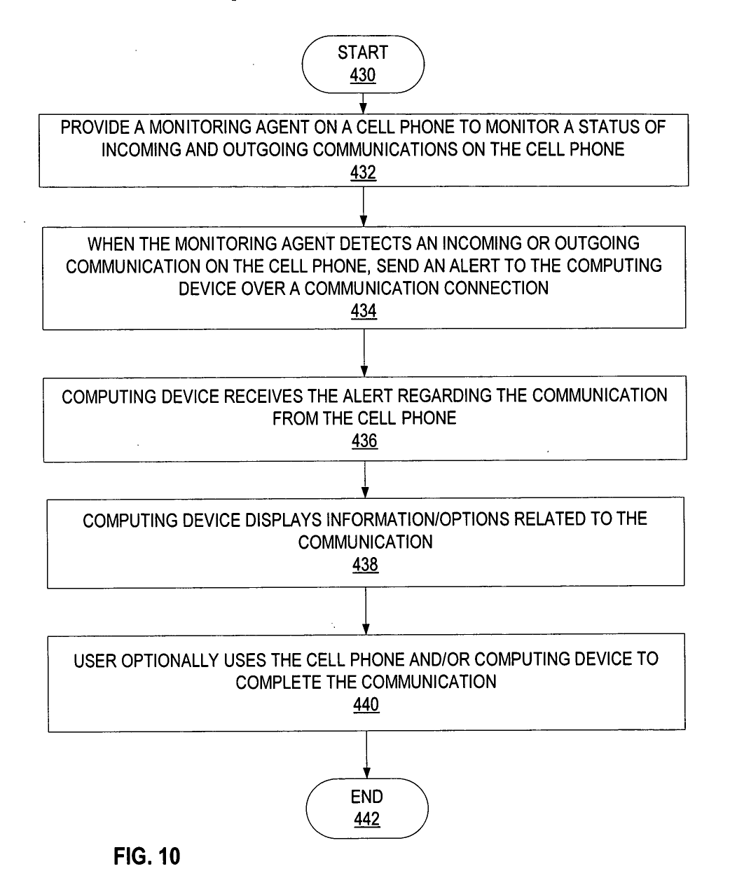

FIG. 10 illustrates one implementation of the stages involved in receiving an alert from a cell phone to indicate a communication is in progress so additional information/options can be provided. In one form, the process of FIG. 10 is at least partially implemented in the operating logic of computing device 100. The procedure begins at start point 430 with providing a monitoring agent on a cell phone to monitor the status of incoming and outgoing communications on the cell phone (stage 432). When the monitoring agent detects an incoming or outgoing communication on the cell phone, an alert is sent to the computing device over a communication connection (stage 434). The computing device receives the alert regarding the communication from the cell phone (stage 436). The computing device displays information/options related to the communication (stage 438). The user optionally uses the cell phone and/or computing device to complete the communication (stage 440). The process ends at end point 442.

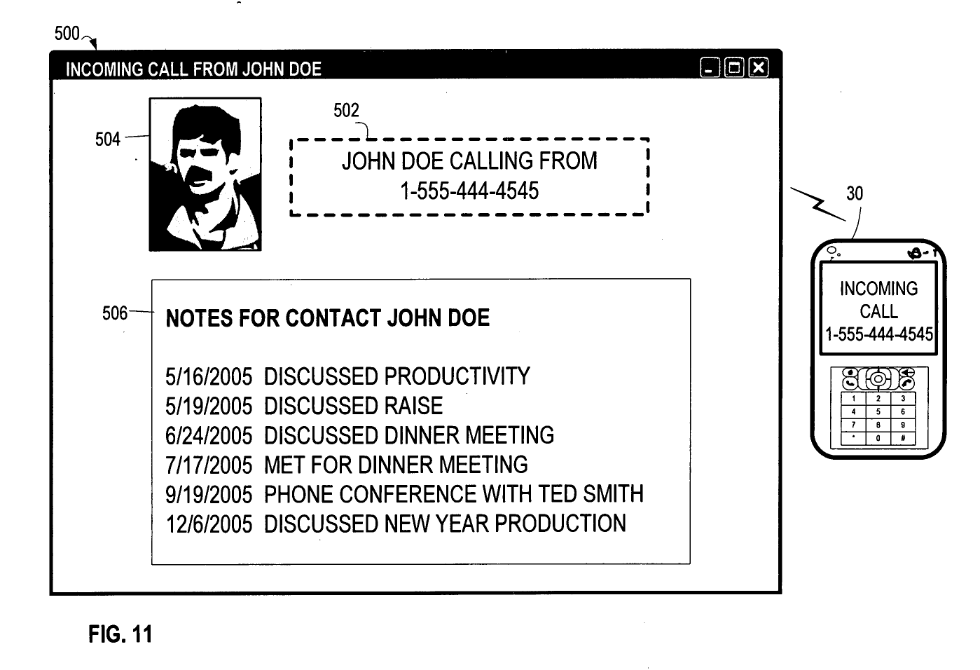

Turning now to FIGS. 11-14, simulated screens are shown to further illustrate the stages of FIGS. 4-10 and the system of FIG. 1. FIGS. 11-14 include non-limiting examples of various user interfaces that allow a user of a computing device (e.g. computing device 100) to use device communicator application 200 in combination with a cell phone. These screens can be displayed to users on output device(s) 111. Furthermore, these screens can receive input from users from input device(s) 112.

FIG. 11 is a simulated screen 500 for one implementation that illustrates the stages of FIG. 4 for displaying additional communication information on a computing device when a communication (incoming or outgoing) is in process on a cell phone 30. In the example shown, additional communication information includes detailed caller identification information 502, a photo of the caller 504, and notes 506 regarding the particular caller, such as the last communications with the caller. Numerous other variations of information instead of or in addition to those shown in FIG. 11 could also be used, such as information from one or more databases that have information related to the particular caller that might be useful during the call or other communication.

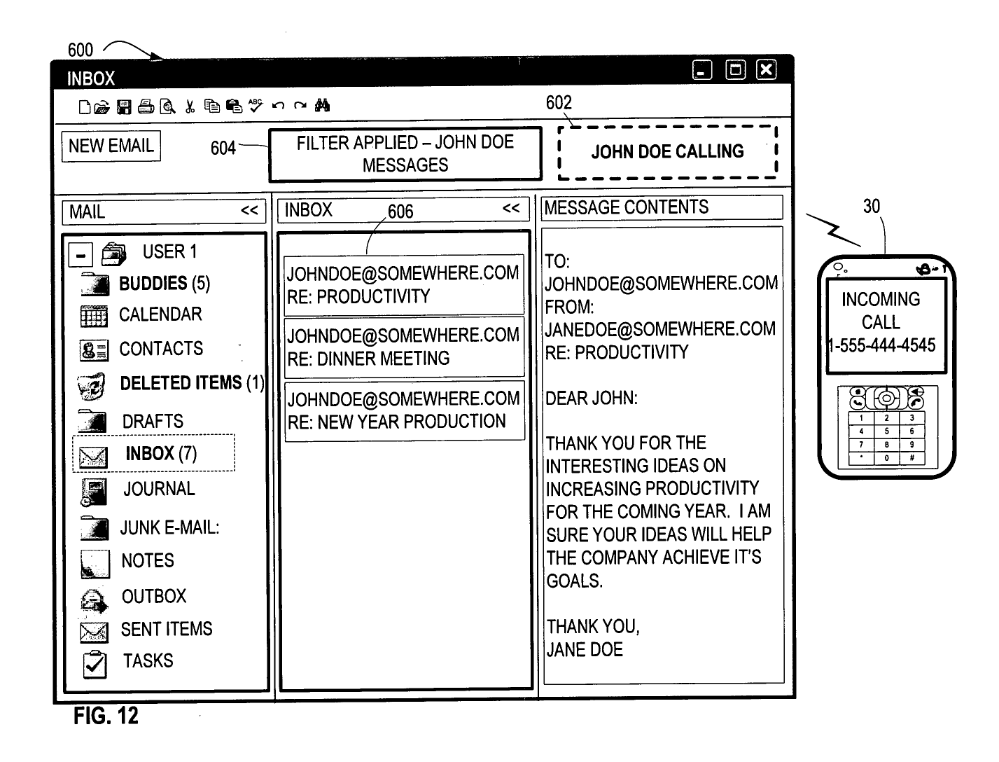

FIG. 12 is a simulated screen 600 for one implementation that illustrates the stages of FIG. 5 for displaying on a computing device an email inbox filtered with messages from the incoming caller when an incoming communication is being received on a cell phone 30. In the example shown in FIG. 12, a status message 602 is displayed to indicate that John Doe is calling, and the email inbox 606 the user is operating in has been filtered 604 to show only messages from the caller John Doe.

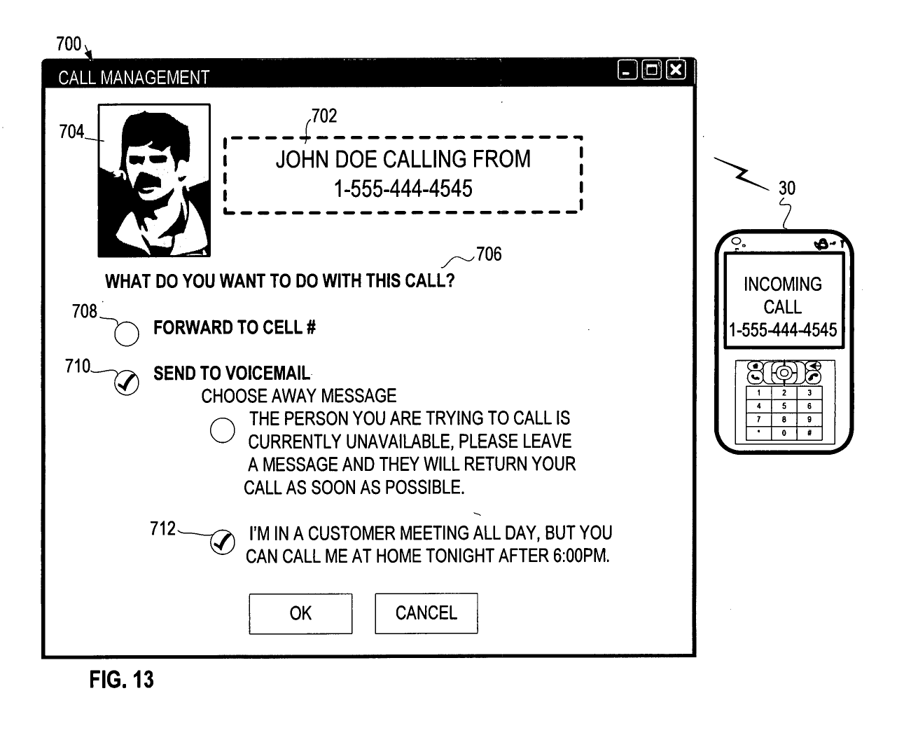

FIG. 13 is a simulated screen 700 for one implementation that illustrates the stages of FIG. 6 for displaying call management options when an incoming call is being received on a cell phone 30. In the example shown, detailed caller identification information 702 is displayed, along with a photo of the caller 704. Other call management options 706 are also shown, such as options allowing the user to forward the cell phone call to his/her cell phone 708, to send the call to voice mail 710, and the type of greeting to use for the voice mail. One non-limiting example of a customized voice mail greeting 712 is shown that the user could choose to use for the voice mail greeting for the current incoming call on cell phone 30.

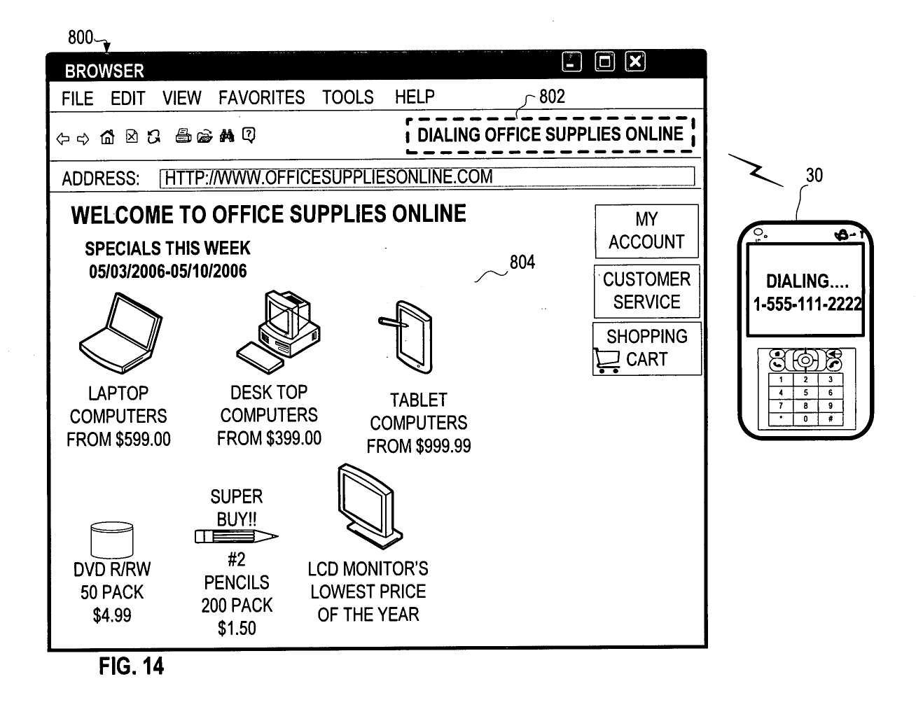

Turning now to FIG. 14, a simulated screen 800 for one implementation is shown for the stages of FIG. 8 that illustrates automatically displaying on a computing device the web site of a party being called (or from whom the user is being called) on a cell phone 30. In this example, an indicator 802 is shown in the web browser to indicate an outgoing call is in progress. In addition, the web site 804 associated with the party being called (or calling) is retrieved from a database and opened automatically in the web browser. This allows the user to interact with the web site while the call is in progress. In the example shown, the company being called is an office supply store, and the web site for that store is shown. The user can simultaneously access the web site information while talking on the phone, such as to verify availability of a particular product the user is interested in.

The simulated screens in FIG. 11-14 show only a few examples of the types of additional information and/or communication management options that could be provided on computing device 100 (such as a personal computer) for use in combination with a cell phone.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for using a computing device to enhance an ongoing cell phone communication comprising the steps of:
determining from a separate computing device that a communication is in progress on a cell phone;
retrieving information from a data store, the information being related to a party participating in the communication; and
displaying at least a portion of the information on a display device of the separate computing device for at least a portion of time that the communication is in progress on the cell phone.

2. The method of claim 1, wherein the displayed information includes a caller identification that further identifies the party participating in the communication.

3. The method of claim 1, wherein the displayed information includes a photo of the party participating in the communication.

4. The method of claim 1, wherein the displayed information includes at least a partial history of prior communications with the party participating in the communication.

5. The method of claim 4, wherein the partial history of prior communications includes at least one email.

6. The method of claim 4, wherein the partial history of prior communications includes at least one note describing a prior conversation.

7. The method of claim 1, wherein the communication is selected from the group consisting of an incoming communication and an outgoing communication.

8. The method of claim 1, wherein the separate computing device determines that a communication is in progress by communicating with the cell phone over a communication connection, the communication connection being selected from the group consisting of a wired connection and a wireless connection.

9. The method of claim 1, wherein the separate computing device determines that the communication is in progress on the cell phone by monitoring the cell phone over a communication connection.

10. The method of claim 1, wherein the separate computing device determines that the communication is in progress on the cell phone by receiving an alert from the cell phone over a communication connection.

11. A computer-readable medium having computer-executable instructions for causing a computer to perform the steps recited in claim 1.

12. A method for using a computing device to manage an ongoing cell phone communication comprising the steps of:
determining from a separate computing device that a communication is in progress on a cell phone;
displaying at least one management option related to the communication, the at least one management option being displayed on a display device of the separate computing device;
receiving input from a user to manage the communication from the separate computing device using the at least one management option; and
responding to the input from the user to manage the communication from the separate computing device.

13. The method of claim 12, wherein the separate computing device determines that the communication is in progress on the cell phone by monitoring the cell phone over a communication connection.

14. The method of claim 12, wherein the separate computing device determines that the communication is in progress on the cell phone by receiving an alert from the cell phone over a communication connection.

15. The method of claim 12, wherein the at least one management option includes a voice mail option to allow the user to send the communication to a voice mail.

16. The method of claim 15, wherein the at least one voice mail option includes a customization option to allow the user to specify a particular voice mail greeting to use.

17. A computer-readable medium having computer-executable instructions for causing a computer to perform the steps recited in claim 12.

18. A computer-readable medium having computer-executable instructions for causing a computer to perform steps comprising:
communicate with a cell phone over a communication connection to determine that a communication is in progress on the cell phone;
retrieve information from a data store located separately from the cell phone, the information being related to a party participating in the communication; and
display at least a portion of the information on a display device located separately from the cell phone for at least a portion of time that the communication is in progress on the cell phone.

19. The computer-readable medium of claim 18, further having computer-executable instructions for causing a computer to perform the step comprising:
display at least one management option related to the communication, the management option being displayed on the display device.

20. The computer-readable medium of claim 18, further having computer-executable instructions for causing a computer to perform the step comprising:
receive input from a user to manage the communication using the at least one management option.
